(19) United States
(12) Patent Application Publication
(10) Pub. No.: US 2016/0140775 A1
(43) Pub. Date: May 19, 2016

(54) METHOD AND APPARATUS FOR MOBILE TICKETING

(71) Applicant: NOKIA TECHNOLOGIES OY, Espoo (FI)

(72) Inventors: Jan-Erik EKBERG, Vantaa (FI); Jarkko Oskari SEVANTO, Helsinki (FI)

(21) Appl. No.: 14/898,405

(22) PCT Filed: Jul. 2, 2013
(86) PCT No.: PCT/FI2013/050726

§ 371 Date: Dec. 14, 2015

(51) Int. Cl. G07B 15/02; G06Q 20/32; G06Q 20/40; G06Q 20/04

(52) U.S. Cl. CPC G07B 15/02; G06Q 20/0457; G06Q 20/3278; G06Q 20/405

(57) ABSTRACT

An apparatus (100, 152, 130) configured to participate in an identity-based mobile transport ticketing event; and to use in said mobile transport ticketing event a transport certificate (Cert), wherein an issuer of the transport certificate (Cert)) is a first transport network (130) and the transport certificate (Cert) comprises roaming attributes usable in a second transport network (150, to determine whether to authorize use of a service in said second transport network (150, 152).

### TECHNICAL FIELD

The present application generally relates to mobile ticketing e.g. for transport operators.

### BACKGROUND

In a mobile ticketing system, a ticketing backend provides a ticketing service and possibly fare calculation for transport operators. The protocol that is used is identity based, i.e. the ticketing backend certifies a key in a user device, and using an identity verification protocol with this key (and a valid certificate) the user device can bind identity of the user of the user device to a “tap” event, i.e. a place and time the user of the user device entered or exited the transport system.

It is desirable that users of a mobile ticketing system can use the same payment method in foreign countries and/or foreign transport networks, i.e. the users should be able to roam between different transport networks.

### SUMMARY

Various aspects of examples of the invention are set out in the claims.

According to a first example aspect of the present invention, there is provided an apparatus, comprising:
a memory unit;
an input/output interface; and
a processor configured to:
   participate in an identity-based mobile transport ticketing event; and
   use in said mobile transport ticketing event a transport certificate, wherein an issuer of the transport certificate is a first transport network and the transport certificate comprises roaming attributes usable in a second transport network to determine whether to authorize use of a service in said second transport network.

In an example embodiment the apparatus is a user device, and the processor is configured to:
interact with a ticket validation device through said input/output interface; and
use said transport certificate in course of said interaction.

In an example embodiment the processor of the user device is configured to send the transport certificate to the ticket validation device.

In an example embodiment the processor of the user device is configured to determine whether to authorize use of a service in the second transport network based on the transport certificate and the roaming attributes thereof and the interaction with the ticket validation device.

In an example embodiment the apparatus is a ticket validation device, and the processor is configured to:
interact with a user device through said input/output interface;
receive from the user device a transport certificate, and
use said transport certificate and the roaming attributes thereof to determine whether to authorize use of a service in the second transport network.

In an example embodiment the apparatus is a ticketing backend of the first transport network, and the processor is configured to:

issue the transport certificate, and
provide said transport certificate to a user device of a user through said input/output interface.

According to a second example aspect of the present invention, there is provided a method comprising:

participating in an identity-based mobile transport ticketing event; and using in said mobile transport ticketing event a transport certificate, wherein an issuer of the transport certificate is a first transport network and the transport certificate comprises roaming attributes usable in a second transport network to determine whether to authorize use of a service in said second transport network.

In an example embodiment the method further comprises:
storing the transport certificate in a user device;
interacting with a ticket validation device; and
using said transport certificate in course of said interaction.

In an example embodiment the method further comprises:
interacting with a user device;
receiving from the user device the transport certificate, and
using said transport certificate to determine whether to authorize use of a service.

In an example embodiment the method further comprises:
issuing the transport certificate by the first transport network system, and
providing said transport certificate to a user device of a user.

In an example embodiment the foregoing roaming attributes comprise values indicating credit limits for the user.

In an example embodiment the foregoing roaming attributes comprise a reservation amount.

In an example embodiment the foregoing roaming attributes comprise a counter pre-adjustment value.

In an example embodiment the foregoing roaming attributes comprise a credit history value.

In an example embodiment the foregoing roaming attributes comprise a payment means value.

According to a third example aspect of the present invention, there is provided a non-transitory computer-readable memory medium encoded with instructions that, when executed by a computer, perform any of the foregoing methods.

According to a fourth example aspect of the present invention, there is provided a computer program, comprising code for performing any of the foregoing methods, when the computer program is run on a processor.

According to a fifth example aspect of the present invention, there is provided a computer program, comprising:
code for participating in an identity-based mobile transport ticketing event; and
code for using in said mobile transport ticketing event a transport certificate,
wherein an issuer of the transport certificate is a first transport network and the transport certificate comprises roaming attributes usable in a second transport network to determine whether to authorize use of a service in said second transport network,
when the computer program is run on a processor.

The computer program of any preceding example aspects may be a computer program product comprising a computer-readable medium bearing computer program code embodied therein for use with a computer.

According to a sixth example aspect of the present invention, there is provided a computer-readable medium encoded with instructions that, when executed by a computer, perform the method of any of the preceding example aspects.

Any foregoing memory medium may comprise a digital data storage such as a data disc or diskette, optical storage, magnetic storage, holographic storage, opto-magnetic storage, phase-change memory, resistive random access memory, magnetic random access memory, solid-electrolyte memory, ferroelectric random access memory, organic memory or polymer memory. The memory medium may be formed into a device without other substantial functions than storing memory or it may be formed as part of a device with other functions, including but not limited to a memory of a computer, a chip set, and a sub assembly of an electronic device.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

For a more complete understanding of example embodiments of the present invention, reference is now made to the following descriptions taken in connection with the accompanying drawings in which:

FIG. 1A shows a block diagram of a mobile ticketing environment according to an example embodiment;

FIG. 1B shows a block diagram of a roaming scenario according to an example embodiment;

FIG. 2 shows an architectural overview of a system of an example embodiment;

FIG. 3 shows a flow diagram of the operation in a user device according to an example embodiment;

FIG. 4 shows a flow diagram of the operation in a ticket validation device according to an example embodiment; and

FIG. 5 shows a flow diagram of the operation in a ticketing backend according to an example embodiment.

### DETAILED DESCRIPTION OF THE DRAWINGS

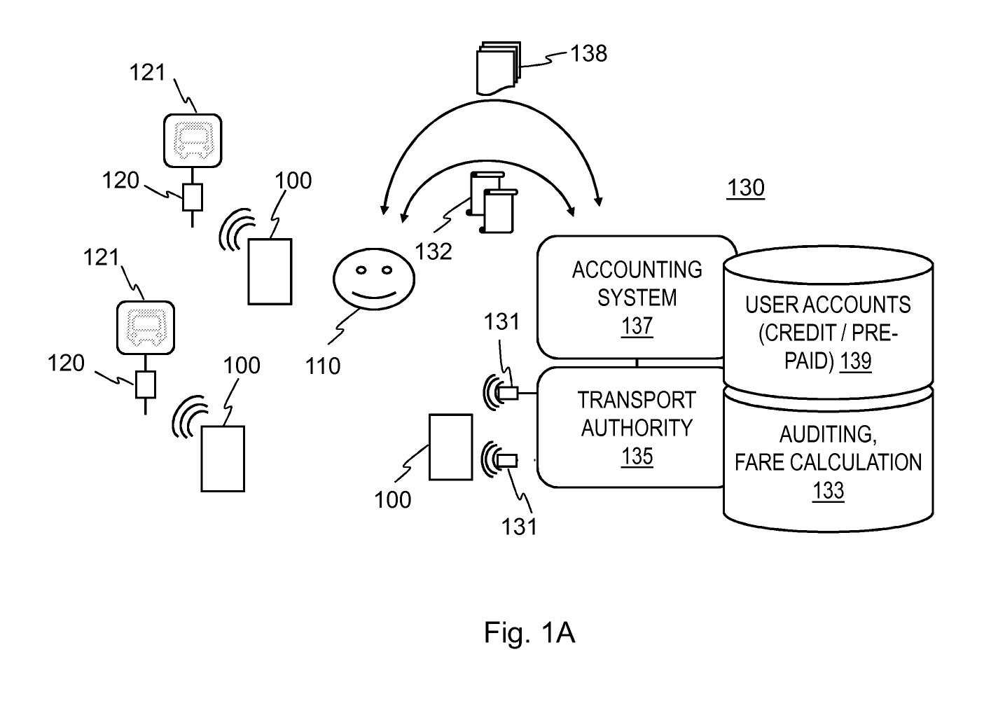

Example embodiments of the present invention and their potential advantages are understood by referring to FIGS. 1A through 5 of the drawings. In this document, like reference signs denote like parts or steps.

In an example mobile ticketing system identity based user authorization is used. User's right to travel is defined in an attribute certificate. An attribute certificate declares the subject's rights to access particular objects. Herein the attribute certificate is called a transport certificate. In general, an identity based mobile ticketing system refers to a system wherein a ticketing backend system certifies a key in a user device, and using an identity verification protocol with this key (and a valid certificate) the user device and the transport system can bind identity of the user of the user device to a “tap” event, i.e. a place and time the user of the user device entered or exited the transport system.

Various embodiments of the invention relate to participating in an identity-based mobile transport ticketing event. This may refer to an event of issuing the transport certificate, validating a ticket for a transport system, interacting between a user device and a ticket reader terminal, clearing fares between transport backends or to some other event relating to one or more tasks performed by certain entity of a mobile transport ticketing system.

FIG. 1A shows a block diagram of a mobile ticketing environment according to an example embodiment. The diagram shows a user 110, plurality of user devices 100, and non-gated readers 120 and gated readers 131 configured to interact with the user devices 100. A transport authority 135 operates and maintains the non-gated ticket readers or terminals 120, and the gated readers 131. The non-gated ticket readers reside for example onboard a vehicle 121 or in connection with bus stops or the like. Some gated readers 131 are in an example embodiment connected, directly or indirectly to a backend system 130 of the transport authority 135. The readers 131, which are connected to the backend system 130, can receive from the backend system 130 information, which they refer to during user authorization. The gated readers 131 are for example near-field communication (NFC) readers.

The backend system 130 comprises a user account storage 139, an accounting system 137, a fare calculation engine 133, or a combination thereof. The fare calculation engine 133 may be a database maintained by the transport authority 135. The parts 137, 139, 133 are in an example embodiment implemented as separate servers or as one or more combined servers. In the foregoing, all systems of the transport authority are referred to as the backend or backend system.

In some example embodiments, the backend system 130 issues transport certificates 132 to users of user devices 100. In an example embodiment, the backend 130 is also responsible for generating ticketing credentials and provisioning secrets to the user devices 100. In some example embodiments, all or some of the information exchanged during a user authorization is transferred as transaction evidence 138 and forwarded from user devices 100 to a processing unit of the backend system 130 of the transport authority 135.

In an example embodiment, the backend 130 of the transport authority 135 is responsible for fare collection from the users of devices 100. The backend 130 of the transport authority 135 can simultaneously be connected to several accounting authorities 137. Additionally, all users may have a relationship with at least one accounting authority 137, in the form of a prepaid or credit-based user account 139. In an example embodiment, user account statuses can be used for determining user history that can affect the services provided to the user. In an example embodiment, the accounting authority 137 is responsible for a cryptographic validation of transport evidence and user device and identity use statistics.

It is desirable that users of a mobile ticketing system can use the same payment method in different networks e.g. when visiting foreign countries and/or foreign transport networks, i.e. the users should be able to roam between different transport networks. For this purpose it is desirable that a roaming user using a mobile ticketing system is instantly authorized to the foreign system. That is, a roaming user should not be required to register their presence or take some other actions in a foreign country or in a foreign transport network before being able to use the transport services in the foreign country or in the foreign transport network area.

In this document a roaming user refers to a person that is registered to a first transport network (or a home network) and uses services of a second transport network (or a foreign/visited network). Such person may be for example a person travelling to a foreign country or to an area covered by a foreign transport network (outside a home network of the user) or to an area covered by a different transport system than the transport system the user usually uses or to a user that otherwise transfers to an area that is covered by a foreign mobile ticketing backend system (opposite to user's own home mobile ticketing backend system). In an example embodiment the first/home transport network and the second/foreign transport network which a roaming user is visiting are serviced by the same service provider or the service providers operating these transport networks have a mutual roaming agreement.

An operating environment according to an example embodiment of the invention comprises multiple ticketing backends that serve a number of transport authorities. In an example embodiment it is assumed that the ticketing backends will know about each other, i.e. they can validate each other's certificates.

FIG. 1B shows a block diagram of a roaming scenario according to an example embodiment.

The diagram of FIG. 1B shows a user 110, a user device 100 of the user and a backend system 130 of the user's home transport network. Additionally the diagram shows a foreign backend system 150 of a foreign transport network, and a ticket reader terminal or a ticket validation device 152 of the foreign transport network.

In an example embodiment the home backend 130 issues and provisions to the user device 100 a transport certificate 132 that comprises roaming attributes. The roaming attributes are usable in a foreign network for determining whether to provide service to the holder of the transport certificate. The form of the transport certificate and the roaming attributes thereof are discussed in more detail later in this document.

The user device 100 interacts with the ticket reader terminal 152 of the foreign network in order to be authorized to use the services of the foreign network. The authorization is validated on the basis of the roaming attributes in the transport certificate.

In an example roaming scenario, the user device will report the transaction evidence 138 relating to transport services consumed in the foreign network to the home backend 130. The clearance 158 between the home backend 130 and the foreign backend 150 and respective transport authorities will happen a posteriori. The user device 100 is not necessarily needed for the clearance operation.

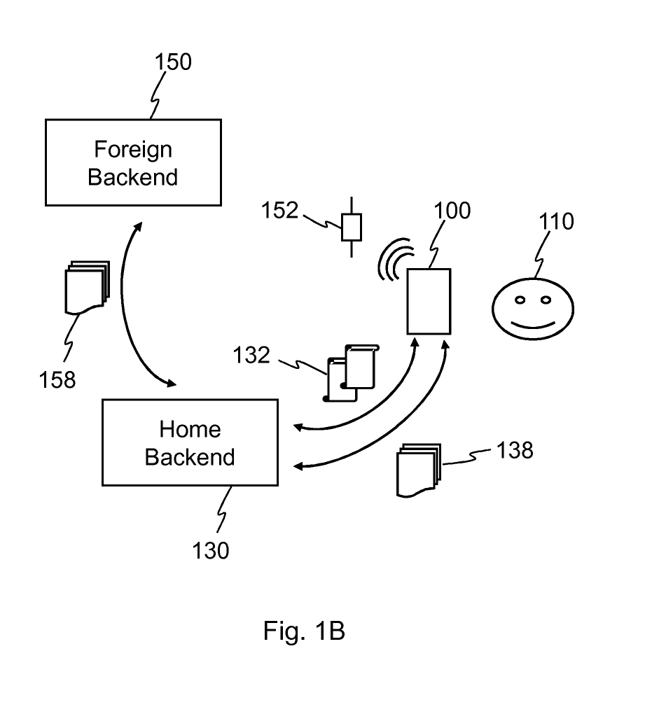

FIG. 2 illustrates an architectural overview of a system suited for performing some example embodiments. The system comprises a user device 100 such as a smart phone and a reader, or terminal, 152 of a foreign transport network. The user device 100 has at least intermittently access to a home backend system 130, such as a server cluster or cloud. The terminal 152 is maintained by a foreign backend system 150 and the terminal 152 may have direct or indirect access to the foreign backend system 150.

The user device 100 is, for example, a portable device such as a mobile phone, a portable gaming device, a chip card ticket, a navigator, a personal digital assistant, a tablet computer or a portable web browser or other electronic portable device. The user device 100 generally has capabilities for processing information, for performing cryptographic operations and for communicating with other entities, such as the home backend 130 and the terminal 152 at least intermittently when in contactless or contacting access with other entities, or with a related communication element.

The user device 100 has a processing circuitry for cryptographic operations, such as a processor 101. Some user devices have a secure environment processing circuitry such as an isolated Trusted Execution Environment (TEE) 111. The user device 100 further has a communication interface 112 such as a near field communication (NFC) interface, near field communication (NFC) interface driver 113, a Logical Link Control Protocol (LLCP) stack 114, a credential manager CM 115, i.e. an interface by which an operating system and/or applications can interact with the processing circuitry for cryptographic operations, and a public transport application 116.

The user device 100 further comprises, in some example embodiments, a user interface, a mobile communication circuitry, an application platform for enabling user installation of applications, and/or a battery for powering the apparatus. In some example embodiments, the user device is externally powered when used, e.g. with electromagnetic induction or with galvanic contacts.

The terminal 152 comprises a communication interface such as a near field communication interface 222, a Logical Link Control Protocol (LLCP) stack 224, an engine 226 that is a processing circuitry for controlling various authentication operations, and a memory 228 that comprises various data needed by the terminal 152 for its operations, including e.g. public authentication key(s). The terminal 152 further comprises processing circuitry for cryptographic operations, such as processor 201, for performing ticket validation on the basis of roaming attributes in a transport certificate of a user device. In some example embodiments, the processing circuitry for cryptographic operations in the user device 100 and in the terminal 152 is isolated as a logically separate function using common hardware circuitries, i.e. a processor 101, 201. In some example embodiments some or all logical elements of the processing circuitry are implemented with dedicated hardware elements. Further in some example embodiments the processing circuitry is implemented by using dedicated applications and common hardware circuitries.

The terminal 152 is in some embodiments a fixedly installed device at a gated or non-gated entrance of a public transport system. In some other embodiments, the terminal 152 is built into a portable device e.g. for use by ticket inspecting personnel.

The home backend system 130 and the foreign backend system 150 are, in some embodiments, servers operated by service providers and that have communication capabilities for exchanging information directly or indirectly with the user device 100 and/or with the terminal 152. The servers comprise a processor that is configured to perform their tasks. In some embodiments the home backend system 130 and the foreign backend system 150 are capable of communicating with each other and capable of settling transport costs related to roaming users.

In an example embodiment, the near field communications (NFC) interface 112 interfaces as provided by currently available hardware and various messages are size optimized. Data transaction between the user device 100 and the terminal 152, e.g. at transport station, is performed using Logical Link Control Protocol (LLCP) over NFC peer-to-peer communication mode. This use of LLCP over NFC can enable using link layer transport service classes, such as connectionless data transmission and connection-oriented data transmission.

In some example embodiments, one or more of the user device 100, the terminal 152, the home backend system 130 and the foreign backend system 150 comprises or comprise other elements, such as user interface device, display, audio device or the like.

Certificates of foreign stakeholders (e.g. other ticketing backends) can be validated in a PKI (public key infrastructure) system. Based on the identity of the user and the validity of the certificate in user's possession it is possible to determine in a foreign backend to which ticketing backend the user reports and whether the certificate of the user is valid. Based on an agreement between different transport authorities this information may grant the user limited ticketing service in any transport service recognizing the ticketing system. Issues in this domain relate to e.g. how much money should a user at least be good for during the validity period of a certificate. The cost of transportation might vary significantly between different parts of the world and between different transport networks and therefore this is not a straightforward issue to resolve. Reserving too much money might limit the user's available funds and reserving too little might increase the risk for the backend and the transport operators.

In an example embodiment the transport certificate is used for providing instant authorization in a foreign system. In an example embodiment the transport certificate is modified with some new values referred to as roaming attributes and the modified transport certificate is used to negotiate certain limits for roaming users. In an example embodiment the transport certificate defines to which degree (up to what amount) a roaming user will get service in a foreign transport network.

In an example embodiment a transport certificate signed by user's home backend system is used in a foreign network to decide on the eligibility of allowing the user to roam.

In an example embodiment the roaming attributes included in a transport certificate indicate credit worthiness of the user or credit limits for the user. In an example embodiment the roaming attributes comprise one or more of the following including any combination thereof:
a reservation amount: an amount an account of a user (in her home system) needs to reserve for the validity time of the user's certificate. This may be a prepaid account value or a credit account value. In an example embodiment this value is in some globally agreed monetary unit, e.g. eurocents.
a counter pre-adjustment value: Number of allowed transactions (identity verifications/taps) that can be performed before the user device is forced to report back to the ticketing backend. This attribute can be used for limiting the use of transport services so that only certain number of transactions is allowed in a foreign transport network. For example: if the counter pre-adjustment value is say 10, then 5 trips can be conducted (each trip consuming two taps: tap in+tap out). After performing the set number of transactions the ticketing backend will automatically become aware of that the user is roaming (and also in which network).
a credit history value: A value representing the credit history between the user's ticketing backend and the user (e.g. trustworthiness of the customer relationship between the user and the ticketing backend). In an example embodiment this value is decided locally, but the value can follow a common norm among ticketing backend providers.
a payment means value: A value describing the payment means the user uses for clearing her ticketing account. In an example embodiment following values can be set 0) prepaid 1) local bank account 2) mobile operator charging 3) global credit card. Clearly there are also other options.

It is to be noted that in an example embodiment the roaming attributes do not indicate true remaining monetary value but rather credit limits associated with the user.

In an example embodiment it is noted that if the value of counter pre-adjustment value multiplied by maximum ticketing price is less than the reservation amount, there will not be any financial risk for the transport authority in allowing roaming users to use transport services. Otherwise, the credit history value and the payment means value can be used for evaluating possible risk caused by allowing roaming users to use transport services.

In an example embodiment a travel authority may set the reservation amount to 10 euros and the counter pre-adjustment value to 10. In this case a roaming user is able to make 5 journeys (2 taps for each journey). If the value of one journey in the transport network is 2 euros, there is no risk for the travel authority. If some journey (e.g. airport train) in the transport network costs e.g. 20 euros, there is clearly a risk for the travel authority. In such case the travel authority may set the reservation amount e.g. to 20 or 30 euros instead of 10 euros to lower the risk.

In yet another embodiment the reservation amount is set to describe a unit cost (cost of a single journey) and can be given in a monetary unit (e.g. eurocents).

In an example embodiment the ticketing protocol is adapted to increase the counter pre-adjustment value more than one step at a time (say amounting to the value of a trip so that more expensive trip increases the counter more than less expensive trips). In this way the financial risks of the travel authorities can be minimized.

In an example embodiment the transport certificate is optimized for size in order to be transportable over carriers like NFC. In order to optimize the size, the roaming attributes are coded as bytes rather than as an attribute syntax in an example embodiment.

Following table illustrates transport certificate content according to an example embodiment.

| Field | Pos | Bytes | Description |
|---|---|---|---|
| VerNo | 0 | 1 | Version number of the certificate (0x01) |
| CertType | 1 | 1 | Certificate type (period cert, one-time |
| | | | token) |
| SerNo | 2 | 6 | Issuer-specific certificate serial number |
| C_PAN | 8 | 8 | Customer PAN number (packed BCD |
| | | | format) |
| I_PAN | 16 | 8 | Issuer (authority) PAN number (packed |
| | | | BCD format). For phones this parameter |
| | | | is the Service Provider, for Validation |
| | | | Devices the Public Transport Operator. |
| ValBeg | 24 | 6 | Seconds since UNIX epoch (1.1.1970) |
| ValEnd | 30 | 6 | Seconds since UNIX epoch (1.1.1970) |
| RsvAmount | 36 | 4 | Service-provider reservation amount in |
| | | | EURcents |
| CtrLimit | 40 | 1 | Pre-adjustment value for counter before |
| | | | reporting |
| CreditHistory | 41 | 1 | |
| PaymentType | 42 | 1 | Limited/unlimited. |
| DeviceType | 43 | 1 | |
| Data | 44 | 144 | ASN.1 DER encoding of RSAPublicKey |
| | | | (RFC 3279) for a 1024B key (around |
| | | | 140B). 0-padded |
| Hash | 188 | 32 | SHA2 hash of all fields including PubKey |

Effective data size of the example transport certificate is 220 bytes. An example embodiment leverages the message recovery property of the RSA primitive for the signature encoding:

The transport provider's authority key (TAK) is a 2048b RSA signature key, i.e. it produces 256B signatures.

The transport certificate is encrypted in RSAES-PKCS1-v1_5 (RFC 3447) format, but using the TAK Private key. The decryption will be performed using the TAK public key. Since the effective padding of PKCS1-v1_5 is at minimum 11B, the certificate contents (220B) will always fit in the resulting encryption (220+11<256).

In an example embodiment a party participating in an identity-based mobile transport ticketing event uses in the mobile transport ticketing event a transport certificate, wherein an issuer of the transport certificate is a first transport network and the transport certificate comprises roaming attributes usable in a second transport network to determine whether to authorize use of a service in said second transport network. The party participating in the identity-based mobile transport ticketing event may be for example a user device, a ticket validation/reader device/terminal, or a backend system.

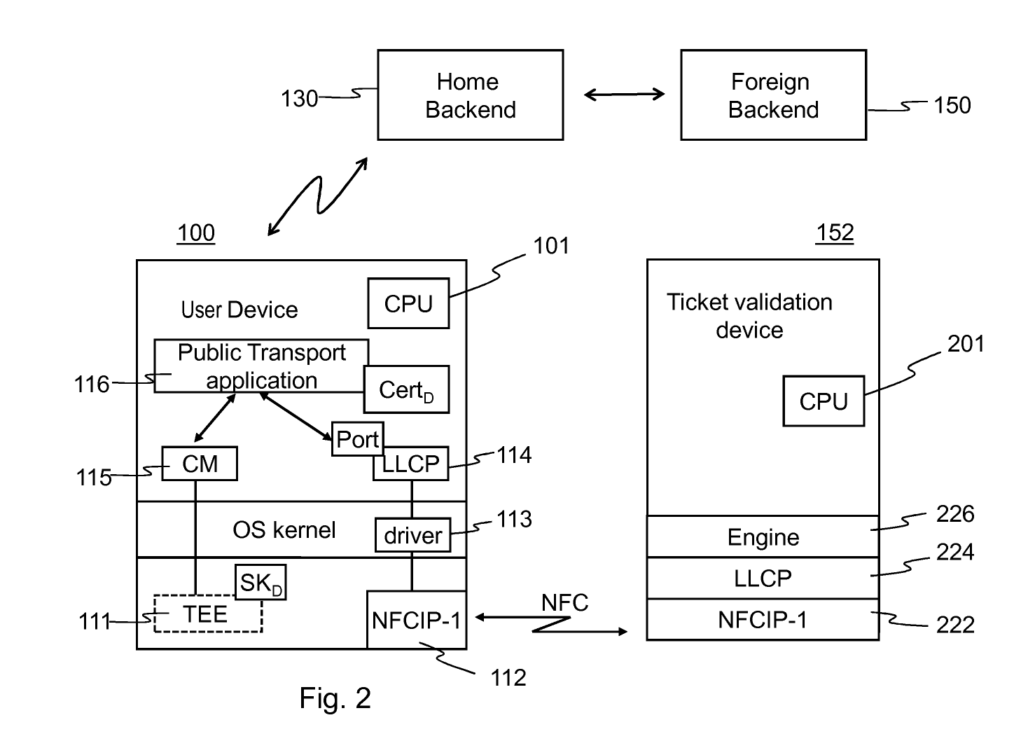

FIG. 3 shows a flow diagram of the operation in a user device according to an example embodiment. The method may be performed e.g. in the user device 100 of FIGS. 1A, 1B and 2.

In step 301, a transport certificate with roaming attributes is stored in a user device. The transport certificate is obtained from a backend system of user's home network.

In step 302, ticket validation in a foreign network is started.

In step 303, the user device interacts with a ticket validation device/terminal in the foreign network and sends the transport certificate to the ticket validation device/terminal. The ticket validation device/terminal will then process the roaming attributes comprised in the transport certificate to determine whether to authorize the user of the user device to use a service in the foreign network. This option is suited for interacting with an active ticket validation device/terminal.

In step 304, the user device interacts with a ticket validation device/terminal in the foreign network and uses the transport certificate and the roaming attributes thereof for ticket validation. This option is suited for interacting with a passive ticket validation device/terminal.

One should note that phases 303 and 304 in FIG. 3 are typically alternatives to each other and that both steps are not necessarily performed. Depending on ticket validation terminal and the ticket validation process the user device may perform either step 303 or step 304.

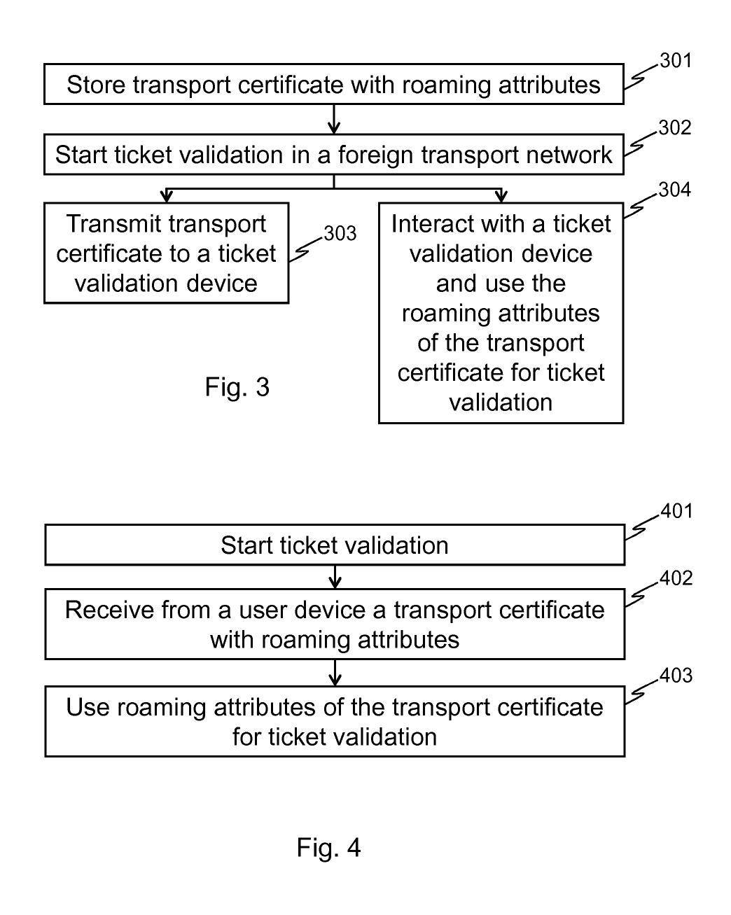

FIG. 4 shows a flow diagram of the operation in a ticket validation device in a foreign network according to an example embodiment. The method may be performed e.g. in the terminals 120, 131, 152 of FIGS. 1A, 1B and 2.

In step 401, a ticket validation process is started.

In step 402, a transport certificate is received from a user device. The transport certificate is issued by a home transport network system of the user of the user device and comprises roaming attributes.

In step 403, the transport certificate and the roaming attributes thereof are used for ticket validation, i.e. to determine whether to authorize the user to use a service in the foreign network.

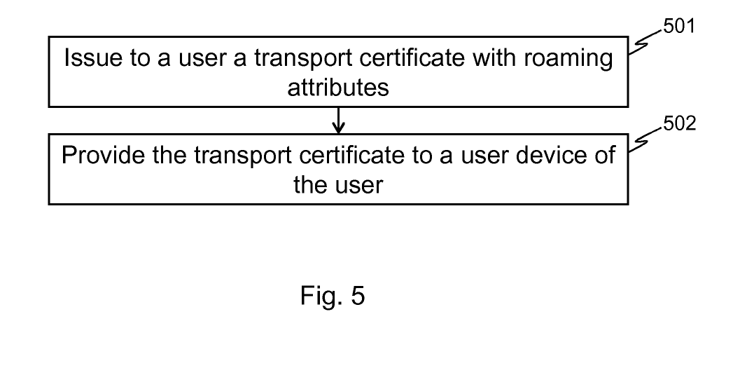

FIG. 5 shows a flow diagram of the operation in a ticketing backend according to an example embodiment. The method may be performed e.g. in the backend system 130 of FIGS. 1A, 1B and 2.

In step 501, a transport certificate is issued for a user. The transport certificate comprises roaming attributes usable in a foreign network to determine whether to authorize use of a service in the foreign network.

In step 502, the transport certificate is provided to a user device of the user.

In an example embodiment, the operation of FIG. 5 continues later on with receiving transport evidence from the user device. If the transport evidence comprises evidence relating to use of services in a foreign network the ticketing backend communicates with the respective backend of the foreign network to settle the costs of those services.

Without in any way limiting the scope, interpretation, or application of the following claims, a technical effect of one or more of the example embodiments disclosed herein is providing an off-line mechanism for determining credit worthiness of a roaming user in a foreign network without prior interaction between the user and the foreign network. Another technical effect of one or more of the example embodiments disclosed herein obtaining a secure way to allow ticketing for roaming users. Yet another technical effect of one or more of the example embodiments disclosed herein is possibility to set limits to possible risks of the transport authorities and backend systems with regard to serving roaming users. Still another technical effect of one or more of the example embodiments disclosed herein is enhancing an identity-based mobile ticketing system where the identity provider is not a global player and improving user experience therein.

Embodiments of the present invention are implemented in software, hardware, application logic or a combination of software, hardware and application logic. In an example embodiment, the application logic, software or an instruction set is maintained on any one of various conventional computer-readable media. In the context of this document, a “computer-readable medium” is any non-transitory media or means that can contain, store, communicate, propagate or transport the instructions for use by or in connection with an instruction execution system, apparatus, or device, such as a computer, with one example of a computer described and depicted in FIG. 2. A computer-readable medium may comprise a computer-readable storage medium that is any media or means that can contain or store the instructions for use by or in connection with an instruction execution system, apparatus, or device, such as a computer.

If desired, the different functions discussed herein are performed in a different order and/or concurrently with each other. Furthermore, if desired, one or more of the before-described functions is optional or is combined. Furthermore it is possible to combine features of one particular embodiment with features of any other embodiment discussed herein.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the foregoing describes example embodiments of the invention, these descriptions should not be viewed in a limiting sense. Rather, there are several variations and modifications which are made without departing from the scope of the present invention as defined in the appended claims.

1-23. (canceled)

24. An apparatus, comprising:
a memory unit;
an input/output interface; and
a processor configured to:
participate in an identity-based mobile transport ticketing event; and
use in said mobile transport ticketing event, a transport certificate, wherein an issuer of the transport certificate is a first transport network and the transport certificate comprises roaming attributes usable in a second transport network to determine whether to authorize use of a service in said second transport network.

25. The apparatus of claim 24, wherein the roaming attributes comprise values indicating credit limits for the user.

26. The apparatus of claim 24, wherein the roaming attributes comprise a reservation amount.

27. The apparatus of claim 24, wherein the roaming attributes comprise a counter pre-adjustment value.

28. The apparatus of claim 24, wherein the roaming attributes comprise a credit history value.

29. The apparatus of claim 24, wherein the roaming attributes comprise a payment means value.

30. The apparatus of claim 24, wherein:
the apparatus is a user device, and wherein
the processor is configured to:
interact with a ticket validation device through said input/output interface; and
use said transport certificate in course of said interaction.

31. The apparatus of claim 30, wherein the processor is configured to send the transport certificate to the ticket validation device.

32. The apparatus of claim 30, wherein the processor is configured to determine whether to authorize use of a service in the second transport network based on the transport certificate and the roaming attributes thereof and the interaction with the ticket validation device.

33. The apparatus of claim 24, wherein
the apparatus is a ticket validation device, and wherein
the processor is configured to:
interact with a user device through said input/output interface;
receive from the user device a transport certificate, and
use said transport certificate and the roaming attributes thereof to determine whether to authorize use of a service in the second transport network.

34. The apparatus of claim 24, wherein
the apparatus is a ticketing backend of the first transport network, and wherein
the processor is configured to:
issue the transport certificate, and
provide said transport certificate to a user device of a user through said input/output interface.

35. A method comprising:
participating in an identity-based mobile transport ticketing event; and
using in said mobile transport ticketing event, a transport certificate, wherein an issuer of the transport certificate is a first transport network and the transport certificate comprises roaming attributes usable in a second transport network to determine whether to authorize use of a service in said second transport network.

36. The method of claim 35, wherein the roaming attributes comprise values indicating credit limits for the user.

37. The method of claim 35, wherein the roaming attributes comprise a reservation amount.

38. The method of claim 35, wherein the roaming attributes comprise a counter pre-adjustment value.

39. The method of claim 35, wherein the roaming attributes comprise a credit history value.

40. The method of claim 35, wherein the roaming attributes comprise a payment means value.

41. The method of claim 35, comprising:
storing the transport certificate in a user device;
interacting with a ticket validation device; and
using said transport certificate in course of said interaction.

42. The method of claim 35, comprising:
interacting with a user device;
receiving from the user device the transport certificate, and
using said transport certificate to determine whether to authorize use of a service.

43. A non-transitory computer-readable memory medium encoded with instructions that,
when executed by a computer, perform the steps of :participating in an identity-based
mobile transport ticketing event; and
using in said mobile transport ticketing event, a transport certificate, wherein an issuer of the transport certificate is a first transport network and the transport certificate comprises roaming attributes usable in a second transport network to determine whether to authorize use of a service in said second transport network.
